(19) United States
(12) Patent Application Publication
(10) Pub. No.: US 2019/0393604 A1
(43) Pub. Date: Dec. 26, 2019

(54) ANTENNA DEVICE, COMMUNICATION SYSTEM, AND ELECTRONIC APPARATUS

(71) Applicant: Murata Manufacturing Co., Ltd., Nagaokakyo-shi (JP)

(72) Inventor: Keiichi ICHIKAWA, Nagaokakyo-shi (JP)

(21) Appl. No.: 16/553,399

(22) Filed: Aug. 28, 2019

Related U.S. Application Data
(63) Continuation of application No. PCT/JP2019/008539, filed on Mar. 5, 2019.

(30) Foreign Application Priority Data
Mar. 12, 2018 (JP) 2018-044574

(51) Int. Cl. H01Q 7/00; H01Q 1/50; H01Q 5/35; H01Q 9/04; H04B 5/00; H01Q 1/36; H01F 38/14; H02J 50/12

(52) U.S. Cl. CPC H01Q 7/00; H01Q 1/50; H01Q 5/35; H01Q 9/04; H04B 5/0037; H01Q 1/36; H01F 38/14; H02J 50/12; H04B 5/0081

(57) ABSTRACT

An antenna device includes a first inductor that is electrically connected to a first system circuit. A second inductor is connected to the first inductor. The first inductor and the second inductor are connected in series with a second system circuit. The second inductor and a parallel resonant circuit are connected to the first system circuit in parallel with the first inductor. The parallel resonant circuit resonates at a parallel resonant frequency lower than a first communication frequency of the first system circuit.

### CROSS REFERENCE TO RELATED APPLICATIONS

This application claims the benefit of priority to Japanese Patent Application No. 2018-044574 filed on Mar. 12, 2018 and is a Continuation Application of PCT Application No. PCT/JP2019/008539 filed on Mar. 5, 2019. The entire contents of each application are hereby incorporated herein by reference.

### BACKGROUND OF THE INVENTION

### 1. Field of the Invention

The present invention relates to an antenna device, a communication system, and an electronic apparatus, and more particularly, to an antenna device including a plurality of inductors, a communication system including the antenna device, and an electronic apparatus including the antenna device.

### 2. Description of the Related Art

Hitherto, an antenna device including a coil conductor used in common for a first non-contact transmission system and a second non-contact transmission system has been known (see, for example, International Publication No. 2017/122499). In the antenna device described in International Publication No. 2017/122499, the coil conductor includes a first coil portion and a second coil portion connected in series. Both ends of the coil conductor are connected to a circuit of the first non-contact transmission system, and both ends of the first coil portion are connected to a circuit of the second non-contact transmission system. Then, the second coil portion is coupled to the first coil portion with a magnetic field located therebetween.

In the existing antenna device described in International Publication No. 2017/122499, since a switch for switching between the two systems (the first non-contact transmission system and the second non-contact transmission system) is required, there has been a problem in that a circuit configuration including a control system becomes complicated. On the other hand, when an antenna device is provided with a coil conductor used in common in two systems without using a configuration such as a switch, and when the coil conductor is used in one of the systems, a communication distance decreases in some cases.

### SUMMARY OF THE INVENTION

Preferred embodiments of the present invention provide antenna devices that are each able to significantly reduce or prevent a decrease in communication distance while significantly reducing or preventing the complication of a circuit configuration, communication systems including the antenna devices, and electronic apparatuses including the antenna devices.

An antenna device according to a preferred embodiment of the present invention operates with a first system circuit that performs wireless communication via a first communication frequency as a carrier frequency and a second system circuit that performs wireless communication via a second communication frequency as a carrier frequency. The antenna device includes a first inductor, a second inductor, and a parallel resonant circuit. The first inductor has a spiral shape, includes a first opening, and is electrically connected to the first system circuit. The second inductor has a spiral shape, includes a second opening that overlaps with the first opening of the first inductor, and is connected to the first inductor. The first inductor and the second inductor are connected in series with the second system circuit. The second inductor and the parallel resonant circuit are connected to the first system circuit in parallel with the first inductor. The parallel resonant circuit resonates at a parallel resonant frequency lower than the first communication frequency.

A communication system according to a preferred embodiment of the present invention includes an antenna device according to a preferred embodiment of the present invention, the first system circuit, and the second system circuit.

An electronic apparatus according to a preferred embodiment of the present invention includes an antenna device according to a preferred embodiment of the present invention, a circuit board, and a housing. The circuit board includes a system circuit that operates the antenna device. The housing accommodates the antenna device and the circuit board.

According to the antenna devices, the communication systems, and the electronic apparatuses according to preferred embodiments of the present invention, it is possible to significantly reduce or prevent a decrease in communication distance while significantly reducing or preventing the complication of a circuit configuration.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a circuit diagram of a communication system according to a first preferred embodiment of the present invention.

FIG. 2A is a front view of an upper layer of an antenna device according to the first preferred embodiment of the present invention. FIG. 2B is a cross-sectional view of the above antenna device taken along a line X1-X1 in FIG. 2A.

FIG. 3 is a front view of a lower layer of the antenna device according to the first preferred embodiment of the present invention.

FIG. 4A is a graph showing frequency characteristics of a phase of a coil current in the antenna device according to the first preferred embodiment of the present invention. FIG. 4B is a graph showing frequency characteristics of a phase difference of a coil current in the antenna device according to the first preferred embodiment of the present invention.

FIG. 5 is a graph showing a relationship between inductance of a first inductor and a minimum frequency and a maximum frequency in a frequency band of a first communication frequency in the antenna device according to the first preferred embodiment of the present invention.

FIG. 6 is a graph showing a relationship between inductance of a second inductor and the minimum frequency and the maximum frequency in the frequency band of the first communication frequency in the antenna device according to the first preferred embodiment of the present invention.

FIG. 7 is a graph showing a relationship between a coupling coefficient and the minimum frequency and the maximum frequency in the frequency band of the first communication frequency in the antenna device according to the first preferred embodiment of the present invention.

FIG. 8 is a graph showing frequency characteristics of a frequency ratio in the antenna device according to the first preferred embodiment of the present invention.

FIG. 9A is a front view of an electronic apparatus according to the first preferred embodiment of the present invention. FIG. 9B is a cross-sectional view of the electronic apparatus according to the first preferred embodiment of the present invention taken along a line Y1-Y1 in FIG. 9A. FIG. 9C is a cross-sectional view of the electronic apparatus according to the first preferred embodiment of the present invention taken along a line Y2-Y2 in FIG. 9A.

FIG. 10 is a circuit diagram of a communication system according to a first modified example of the first preferred embodiment of the present invention.

FIG. 11 is a circuit diagram of a communication system according to a second modified example of the first preferred embodiment of the present invention.

FIG. 12 is a circuit diagram of a communication system according to a third modified example of the first preferred embodiment of the present invention.

FIG. 13 is a circuit diagram of a communication system according to a fourth modified example of the first preferred embodiment of the present invention.

FIG. 14A is a front view of an upper layer of an antenna device according to a fifth modified example of the first preferred embodiment of the present invention. FIG. 14B is a cross-sectional view of the antenna device according to the first preferred embodiment of the present invention taken along the line X1-X1 in FIG. 14A.

FIG. 15 is a front view of a lower layer of the antenna device according to the first preferred embodiment of the present invention.

FIG. 16 is a front view of an antenna device according to a sixth modified example of the first preferred embodiment of the present invention.

FIG. 17A is a front view of a lower layer of a main portion of the above antenna device. FIG. 17B is a front view of an upper layer of a main portion of the antenna device according to the first preferred embodiment of the present invention.

FIG. 18 is a circuit diagram of a communication system according to a seventh modified example of the first preferred embodiment of the present invention.

FIG. 19 is a circuit diagram of a communication system according to a second preferred embodiment of the present invention.

FIG. 20A is a front view of an upper layer of an antenna device according to the second preferred embodiment of the present invention. FIG. 20B is a cross-sectional view of the antenna device according to the second preferred embodiment of the present invention taken along a line X2-X2 in FIG. 20A.

FIG. 21 is a front view of a lower layer of the antenna device according to the second preferred embodiment of the present invention.

### DETAILED DESCRIPTION OF THE PREFERRED EMBODIMENTS

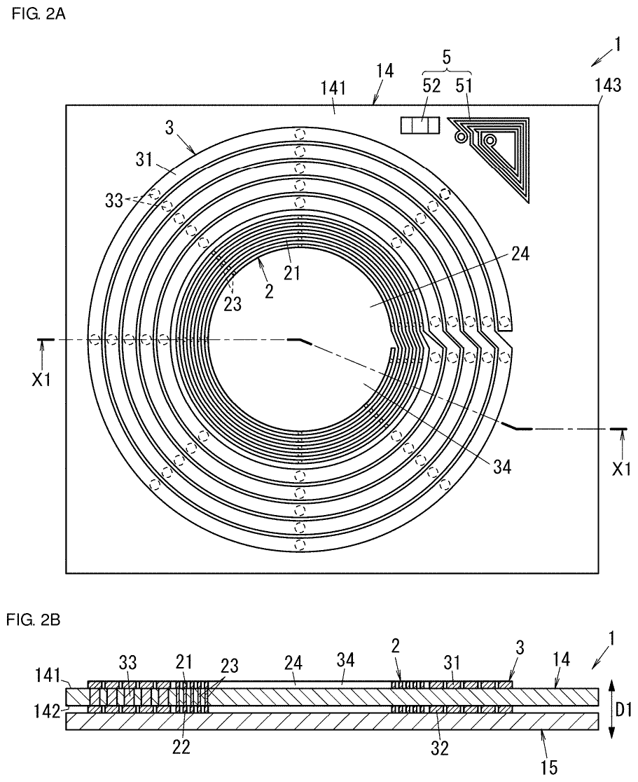

Hereinafter, antenna devices, communication systems, and electronic apparatuses according to preferred embodiments will be described with reference to the accompanying drawings. FIGS. 2A, 2B, FIG. 3, FIGS. 9A to 9C, FIGS. 14A, 14B, FIG. 15, FIG. 16, FIGS. 17A, 17B, FIGS. 20A, 20B and FIG. 21 described in the following preferred embodiments and the like, are schematic diagrams, and sizes, thicknesses, and ratios thereof of respective elements in the figures do not always reflect actual dimension ratios.

An “antenna device” according to each preferred embodiment is an antenna device included in a “wireless transmission system”. Here, the “wireless transmission system” is a system that performs wireless transmission by magnetic field coupling with a transmission partner (an antenna of an external device). The “transmission” includes both meanings of transmission/reception of a signal and transmission/reception of power. Further, the “wireless transmission system” includes both meanings of a short-range wireless communication system and a wireless power supply system. Since the antenna device performs wireless transmission by magnetic field coupling, a length of a current path of the antenna device, that is, a line length of a coil conductor to be described later is sufficiently smaller than a wave length λ at a frequency used in the wireless transmission, and is equal to or less than λ/10. Thus, radiation efficiency of an electromagnetic wave is low in a frequency band used in the wireless transmission. Note that, the wave length λ mentioned here is an effective wave length in consideration of a wave length shortening effect due to dielectricity and permeability of a base material on which the coil conductor is provided. Both ends of the coil conductor are connected to a power supply circuit, and a current of substantially uniform magnitude flows in a current path of the antenna device, that is, the coil conductor.

Further, as short-range wireless communication included in the “antenna device” according to each of the preferred embodiments, for example, Near Field Communication (NFC) may be described. A frequency band used for the short-range wireless communication is preferably, for example, an HF band, and is particularly a frequency band including 13.56 MHz and a vicinity thereof.

Further, examples of a wireless power supply method included in the “antenna device” according to each of the preferred embodiments include, for example, a magnetic field coupling method such as an electromagnetic induction method or a magnetic field resonance method. As wireless power supply standards for the electromagnetic induction method, for example, “Qi (registered trademark)” standards that are defined by Wireless Power Consortium (WPC) may be described. A frequency band used in the electromagnetic induction method is included in, for example, a range of about 110 kHz or more and about 205 kHz or less, and in a frequency band including a vicinity of the range described above. As wireless power supply standards for the magnetic field resonance method, for example, “AirFuel Resonant” standards defined by AirFuel (registered trademark) Alliance may be cited. A frequency band used in the magnetic field resonance method is preferably, for example, a 6.78 MHz band or a 100 kHz band.

### First Preferred Embodiment

### (1) Overall Configuration of Antenna Device

First, an overall configuration of an antenna device according to a first preferred embodiment of the present invention will be described with reference to the accompanying drawings.

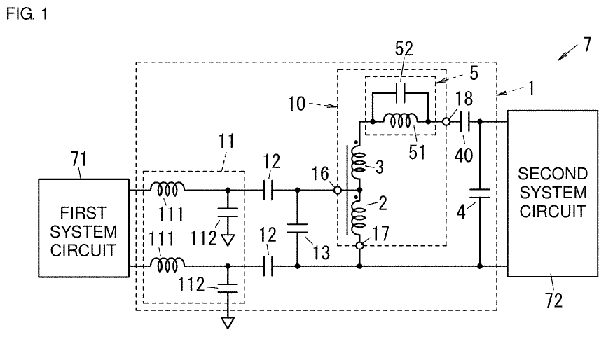

As shown in FIG. 1, the antenna device 1 according to the first preferred embodiment includes a first inductor 2, a second inductor 3, and a parallel resonant circuit 5. As shown in FIG. 2A, the first inductor 2 has a spiral shape and includes a first opening 24. The second inductor 3 has a spiral shape and includes a second opening 34. The second inductor 3 is connected in series with the first inductor 2, and the second opening 34 of the second inductor 3 overlaps with the first opening 24 of the first inductor 2.

As shown in FIG. 1, the antenna device 1 is a device that operates with a first system circuit 71 and a second system circuit 72.

The first system circuit 71 is a circuit that performs wireless communication via a first communication frequency as a carrier frequency. The second system circuit 72 is a circuit that performs wireless communication via a second communication frequency as a carrier frequency. In this case, it is preferable that the first communication frequency is higher than the second communication frequency. For example, as wireless communication via the first communication frequency as a carrier frequency, proximity wireless communication such as NFC is applied, and wireless power supply is applied as wireless communication via the second communication frequency as a carrier frequency.

In the antenna device 1 as described above, a parallel capacitor 13 is connected in parallel with the first inductor 2. The first inductor 2 is electrically connected to the first system circuit 71.

Further, the antenna device 1 includes a capacitor 4 and a capacitor 40. The capacitor 4 is connected to the second system circuit 72 in parallel with the first inductor 2, the second inductor 3, and the parallel resonant circuit 5. A series circuit including the first inductor 2, the second inductor 3, the parallel resonant circuit 5, and the capacitor 40 is electrically connected to the second system circuit 72. Additionally, the first inductor 2 is connected to the first system circuit 71 in parallel with the second inductor 3 and the parallel resonant circuit 5.

The parallel capacitor 13 and the first inductor 2 define a resonant circuit that resonates at the first communication frequency. Further, the series circuit including the first inductor 2, the second inductor 3, the parallel resonant circuit 5, and the capacitor 40 defines a resonant circuit that resonates in a second communication frequency band. The parallel resonant circuit 5 resonates at a parallel resonant frequency lower than the first communication frequency. Impedance of the capacitor 4 in a first communication frequency band is lower than impedance of the capacitor 4 in the second communication frequency band. Further, since the impedance of the capacitor 4 in the first communication frequency band is low, both ends of the capacitor 4 are brought closer to a short-circuit condition. On the other hand, since the impedance of the capacitor 4 in the second communication frequency band is high, both the ends of the capacitor 4 are brought closer to an open circuit condition. Thus, when the first system circuit 71 operates via the first communication frequency as a carrier frequency, a current of a signal at the first communication frequency flows through a current path passing through the capacitor 4. Further, when the second system circuit 72 operates via the second communication frequency as a carrier frequency, a current of a signal at the second communication frequency flows not through the current path passing through the capacitor 4, but through a current path passing through the first inductor 2 and the second inductor 3.

Implementations of the preferred embodiments of the present invention are not limited to the above configuration, and it is sufficient that a circuit has a current path circulating through the first inductor 2, the second inductor 3, and the parallel resonant circuit 5 when the first system circuit 71 operates via the first communication frequency as a carrier frequency. For example, in place of the capacitor 4, a filter circuit whose impedance varies according to a frequency band used may be included. As a circuit element connected to the second system circuit 72 in parallel with the first inductor 2, the second inductor 3, and the parallel resonant circuit 5, instead of providing the capacitor 4 as a mounting component, capacitance of an element (capacitance component) in a circuit may be included. As the above circuit element, parasitic capacitance or the like included in an IC element in the second system circuit 72 may be substituted.

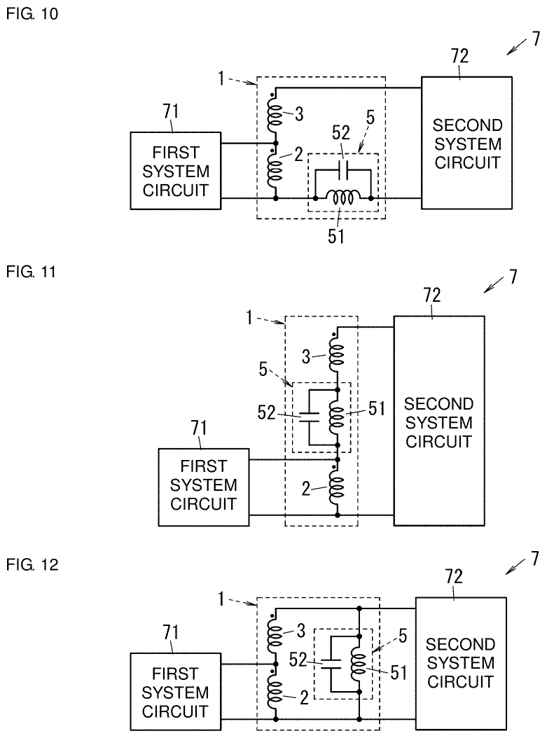

The first inductor 2 is connected to the second system circuit 72 in series with the second inductor 3. As long as the second system circuit 72, the first inductor 2, and the second inductor 3 are connected in series to each other, a connection relationship is not limited to the implementation structure in FIG. 1. Also, a connection relationship of the parallel resonant circuit 5 is not limited to the implementation structure in FIG. 1. For example, a connection relationship of the parallel resonant circuit 5 may be connection relationships shown in FIG. 10 to FIG. 12. In the connection relationship shown in FIG. 10, the parallel resonant circuit 5 is not connected between the second inductor 3 and the second system circuit 72, but is connected between the first inductor 2 and the second system circuit 72. In the connection relationship shown in FIG. 11, the parallel resonant circuit 5 is connected between the first inductor 2 and the second inductor 3. In the connection relationship shown in FIG. 12, the parallel resonant circuit 5 is connected in parallel with a series circuit including the first inductor 2 and the second inductor 3. In FIG. 10 to FIG. 12, circuit elements, such as the capacitor 4, for example, are not shown.

Note that, when the second system circuit 72 appears to be a short circuit in the first communication frequency band, the parallel resonant circuit 5 is preferably connected to the second system circuit 72 in series with the first inductor 2 and the second inductor 3 as shown in FIG. 10 and FIG. 11. That is, when the second system circuit 72 appears to be a short circuit in the first communication frequency band, many currents from the first inductor 2 and the second inductor 3 pass through the parallel resonant circuit 5, so that communication characteristics are improved.

According to the above-described antenna device 1, when the first system circuit 71 operates via the first communication frequency as a carrier frequency, a first current flowing in the first inductor 2 and a second current flowing in the second inductor 3 are able to be prevented from canceling each other out. Alternatively, it is possible to significantly reduce or prevent the first current flowing in the first inductor 2 and the second current flowing in the second inductor 3 from canceling each other out. As a result, it is possible to significantly reduce or prevent a decrease in communication distance in the first system circuit 71 via the first communication frequency as a carrier frequency. Further, since the first current flowing in the first inductor 2 and the second current flowing in the second inductor 3 do not cancel each other out, a magnetic flux generated by the first current and a magnetic flux generated by the second current are able to be generated so as to intensify each other. Thus, it is possible to improve communication characteristics in the first system circuit 71 via the first communication frequency as a carrier frequency.

As described above, the antenna device 1 operates with the first system circuit 71 and the second system circuit 72. That is to say, the antenna device 1 is included in a communication system 7.

As shown in FIG. 1, the communication system 7 includes the antenna device 1, the first system circuit 71, and the second system circuit 72.

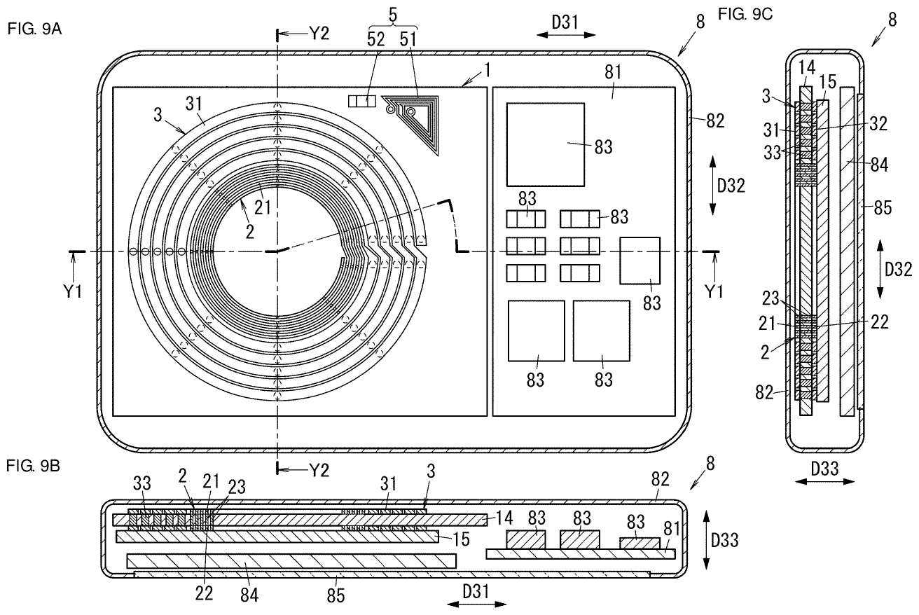

Further, as shown in FIGS. 9A to 9C, the antenna device is mounted on an electronic apparatus 8 and operates as a wireless power supply (including “wireless charging”) to the electronic apparatus 8, for example.

### (2) Elements of Antenna Device

Next, each element of the antenna device 1 according to the first preferred embodiment will be described with reference to the accompanying drawings.

As shown in FIG. 1, the antenna device 1 includes the first inductor 2, the second inductor 3, the capacitor 4, the capacitor 40, and the parallel resonant circuit 5. Additionally, the antenna device 1 further includes a filter 11, a plurality of (for example, two in the illustrated example) series capacitors 12, and the parallel capacitor 13.

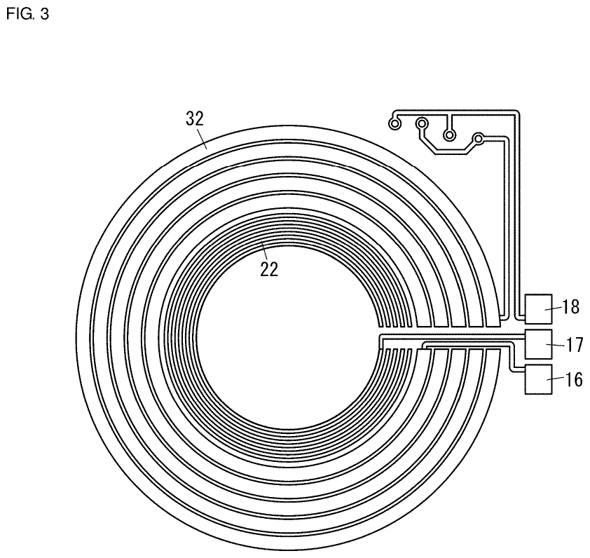

Further, as shown in FIGS. 2A and 2B, the antenna device 1 includes a base material 14 and a magnetic body 15. Further, as shown in FIG. 3, the antenna device 1 further includes three connection terminals (a first connection terminal 16, a second connection terminal 17, and a third connection terminal 18), a first protection layer (not shown), and a second protection layer (not shown). A circuit block 10 shown in FIG. 1 is provided on the base material 14 shown in FIGS. 2A and 2B.

### (2.1) Base Material

As shown in FIGS. 2A and 2B, the base material 14 preferably has a plate or a sheet shape made of an electrically insulating material, such as resin, for example, and includes a first main surface 141 and a second main surface 142 facing each other. Examples of the electrically insulating material included in the base material 14 include, for example, polyimide, Poly Ethylene Terephthalate (PET), and Liquid Crystal Polymer (LCP). The base material 14 preferably has a square or substantially square shape in a plan view from a thickness direction (first direction D1).

The first inductor 2 and the second inductor 3, that are a single member, are integrally provided on the base material 14. Further, the base material 14 is provided with an inductor 51 and a capacitor 52, which will be described later.

Note that, the first main surface 141 of the base material 14 and the second main surface 142 of the base material 14 are parallel or substantially parallel to each other. Further, the first main surface 141 of the base material 14 and the second main surface 142 of the base material 14 are opposed to each other, and a normal direction of the first main surface 141 of the base material 14 and a normal direction of the second main surface 142 of the base material 14 are aligned or substantially aligned with the first direction D1.

### (2.2) First Inductor

As shown in FIG. 1, the first inductor 2 is electrically connected to the first system circuit 71. More specifically, the first inductor 2 is connected to the first system circuit 71 with the filter 11 and a plurality of the series capacitors 12 interposed therebetween. The first inductor 2 defines a resonant circuit together with the parallel capacitor 13. Here, “electrically connected” includes not only direct conduction but also connection via capacitive coupling by a capacitor or the like. In addition, “connected in series” in the present application means “electrically connected in series” unless otherwise specified. “Connected in parallel” means “electrically connected in parallel” unless otherwise specified.

As shown in FIGS. 2A, 2B, and FIG. 3, the first inductor 2 is provided on the base material 14, and is wound in a spiral shape. The first inductor 2 includes the first opening 24. More specifically, the first inductor 2 includes a first coil conductor portion 21, a second coil conductor portion 22, and a plurality of first via conductors 23. In order to reduce a resistance component of the first inductor 2, the first coil conductor portion 21 and the second coil conductor portion 22 are connected in parallel, and the first coil conductor portion 21 and the second coil conductor portion 22 are electrically connected to each other by the plurality of first via conductors 23.

As shown in FIGS. 2A and 2B, the first coil conductor portion 21 is provided in a spiral shape about an axis along the first direction D1. The first coil conductor portion 21 is, for example, wound about five times. The first coil conductor portion 21 is provided on the first main surface 141 of the base material 14 and is preferably made of copper, aluminum, or the like, for example. For example, by etching or printing, a copper film or an aluminum film is formed on the first main surface 141 of the base material 14, to provide the first coil conductor portion 21 on the first main surface 141 of the base material 14.

Similarly to the first coil conductor portion 21, the second coil conductor portion 22 is provided in a spiral shape about the axis along the first direction D1 as shown in FIG. 2B and FIG. 3. The second coil conductor portion 22 is, for example, wound about five times. The second coil conductor portion 22 is provided on the second main surface 142 of the base material 14 and is preferably made of copper, aluminum, or the like, for example. For example, by etching or printing, a copper film or an aluminum film is formed on the second main surface 142 of the base material 14, to provide the second coil conductor portion 22 on the second main surface 142 of the base material 14.

Here, each of the coil conductor portions (the first coil conductor portion 21 and the second coil conductor portion 22) having a spiral shape may be a two-dimensional coil conductor portion having a shape that is wound a plurality of times around a winding axis in a spiral shape on one plane, or may be a three-dimensional coil conductor portion having a shape that is wound a plurality of times in a helical shape around and along a winding axis. FIG. 2A and FIG. 3 show the two-dimensional coil conductor portion.

The second coil conductor portion 22 is located at a position overlapping with the first coil conductor portion 21 in a plan view from the first direction D1. The second coil conductor portion 22 is disposed along the first coil conductor portion 21 in a plan view from the first direction D1. In other words, the second coil conductor portion 22 does not intersect the first coil conductor portion 21, but is disposed such that a longitudinal direction of the second coil conductor portion 22 coincides or substantially coincides with a longitudinal direction of the first coil conductor portion 21.

As described above, since the second coil conductor portion 22 overlaps with the first coil conductor portion 21, the first inductor 2 is able to be prevented from becoming larger while increasing the size of the first opening 24 surrounded by the first coil conductor portion 21 and the second coil conductor portion 22.

As shown in FIGS. 2A and 2B, the plurality of first via conductors 23 are connected in parallel to each other between the first coil conductor portion 21 and the second coil conductor portion 22, and penetrate through the base material 14. As shown in FIG. 2A, the plurality of first via conductors 23 are provided at different positions from each other in a plan view from the first direction D1 to electrically connect the first coil conductor portion 21 and the second coil conductor portion 22. The plurality of first via conductors 23 are provided at different positions from each other within the base material 14.

The first coil conductor portion 21 and the second coil conductor portion 22 are electrically connected to each other by the plurality of first via conductors 23. Accordingly, a current is able to flow in the first direction D1 with the first via conductors 23 located therebetween, so that a resistance component is able to be smaller than that in a case where the first inductor includes only of the first coil conductor portion 21 or only of the second coil conductor portion 22.

### (2.3) Second Inductor

As shown in FIG. 1, the second inductor 3 is connected to the first inductor 2. More specifically, the second inductor 3 includes a first end and a second end, the first end is connected to the first inductor 2, and the second end is connected to the parallel resonant circuit 5. That is, the second inductor 3 defines a series circuit together with the first inductor 2.

As shown in FIGS. 2A, 2B, and FIG. 3, the second inductor 3 is provided on the base material 14, and is wound in a spiral shape. The second inductor 3 includes the second opening 34. The second opening 34 overlaps with the first opening 24 of the first inductor 2. More specifically, the second inductor 3 includes a third coil conductor portion 31, a fourth coil conductor portion 32, and a plurality of second via conductors 33. In order to reduce a resistance component of the second inductor 3, the third coil conductor portion 31 and the fourth coil conductor portion 32 are electrically connected in parallel, and the third coil conductor portion 31 and the fourth coil conductor portion 32 are electrically connected by the plurality of second via conductors 33.

Here, a line width of the second inductor 3 is preferably larger than a line width of the first inductor 2. More specifically, a line width of the third coil conductor portion 31 of the second inductor 3 is preferably larger than a line width of the first coil conductor portion 21 of the first inductor 2. Similarly, a line width of the fourth coil conductor portion 32 of the second inductor 3 is preferably larger than a line width of the second coil conductor portion 22 of the first inductor 2.

Similarly to the first coil conductor portion 21 of the first inductor 2, the third coil conductor portion 31 is provided in a spiral shape about the axis along the first direction D1 as shown in FIGS. 2A and 2B. The third coil conductor portion 31 is, for example, wound about five times. The third coil conductor portion 31 is provided on the first main surface 141 of the base material 14 and is preferably made of copper, aluminum, or the like, for example. For example, by etching or printing, a copper film or an aluminum film is formed on the first main surface 141 of the base material 14, to provide the third coil conductor portion 31 on the first main surface 141 of the base material 14.

Similarly to the second coil conductor portion 22 of the first inductor 2, the fourth coil conductor portion 32 is provided in a spiral shape about the axis along the first direction D1 as shown in FIG. 2B and FIG. 3. The fourth coil conductor portion 32 is, for example, wound about five times. The fourth coil conductor portion 32 is provided on the second main surface 142 of the base material 14 and is made of copper, aluminum, or the like, for example. For example, by etching or printing, a copper film or an aluminum film is formed on the second main surface 142 of the base material 14, to provide the fourth coil conductor portion 32 on the second main surface 142 of the base material 14.

Here, each of the coil conductor portions (the third coil conductor portion 31 and the fourth coil conductor portion 32) provided in a spiral shape may be a two-dimensional coil conductor portion having a shape that is wound a plurality of times around a winding axis in a spiral shape on one plane, or may be a three-dimensional coil conductor portion having a shape that is wound a plurality of times in a helical shape around and along a winding axis. FIG. 2A and FIG. 3 show the two-dimensional coil conductor portion.

The fourth coil conductor portion 32 is located at a position overlapping with the third coil conductor portion 31 in a plan view from the first direction D1. The fourth coil conductor portion 32 is disposed along the third coil conductor portion 31 in a plan view from the first direction D1. In other words, the fourth coil conductor portion 32 does not intersect the third coil conductor portion 31, but is disposed such that a longitudinal direction of the fourth coil conductor portion 32 coincides or substantially coincides with a longitudinal direction of the third coil conductor portion 31.

As described above, since the fourth coil conductor portion 32 overlaps with the third coil conductor portion 31, the second inductor 3 is able to be prevented from becoming larger while increasing the second opening 34 surrounded by the third coil conductor portion 31 and the fourth coil conductor portion 32.

As shown in FIGS. 2A and 2B, the plurality of second via conductors 33 are connected in parallel to each other between the third coil conductor portion 31 and the fourth coil conductor portion 32, and penetrate through the base material 14. As shown in FIG. 2A, the plurality of second via conductors 33 are provided at different positions from each other in a plan view from the first direction D1 to electrically connect the third coil conductor portion 31 and the fourth coil conductor portion 32. The plurality of second via conductors 33 are provided at different positions from each other within the base material 14.

The third coil conductor portion 31 and the fourth coil conductor portion 32 are electrically connected to each other by the plurality of second via conductors 33. Accordingly, a current is able to flow in the first direction D1 with the second via conductors 33 located therebetween, so that a resistance component is able to be smaller than that in a case where the second inductor includes only of the third coil conductor portion 31 or only of the fourth coil conductor portion 32.

### (2.4) Capacitor

As shown in FIG. 1, the capacitor 40 is connected in series with the first inductor 2, the second inductor 3, and the parallel resonant circuit 5.

As shown in FIG. 1, the capacitor 4 is connected in parallel with a series circuit including the first inductor 2, the second inductor 3, the parallel resonant circuit 5, and the capacitor 40. That is, a capacitor 4 is a parallel capacitor. The capacitor 4 is electrically connected to the second system circuit 72.

### (2.5) Parallel Resonant Circuit

As shown in FIG. 1, the parallel resonant circuit 5 is connected in series with the first inductor 2 and the second inductor 3. More specifically, of both ends of the parallel resonant circuit 5, a first end is connected to the second inductor 3, and a second end of both the above ends is connected to the second system circuit 72 with the capacitor 40 located therebetween.

The parallel resonant circuit 5 includes the inductor 51 (an inductance component) and the capacitor 52 (a capacitance component). The inductor 51 is connected in series with the first inductor 2 and the second inductor 3. The capacitor 52 is connected in parallel with the inductor 51.

The parallel resonant circuit 5 defines a series circuit together with the first inductor 2, the second inductor 3, and the capacitor 40. The series circuit including the first inductor 2, the second inductor 3, the parallel resonant circuit 5, and the capacitor 40 is electrically connected to the second system circuit 72.

Further, the first inductor 2, the second inductor 3, the parallel resonant circuit 5, and the capacitor 40 define a resonant circuit that resonates at the second communication frequency.

The parallel resonant circuit 5 resonates at a parallel resonant frequency lower than the first communication frequency of the first system circuit 71.

As shown in FIG. 2A, the parallel resonant circuit 5 is provided outside a region of the base material 14 where the first inductor 2 and the second inductor 3 are provided when viewed in plan from the first direction D1. That is, the inductor 51 and the capacitor 52 are located in a space between the region where the first inductor 2 and the second inductor 3 are provided and a corner 143 of the base material 14.

The inductor 51 is provided on the base material 14 and wound in a spiral shape. More specifically, the inductor 51 is provided in a spiral shape about the axis along the first direction D1. The inductor 51 is, for example, wound about three times. The inductor 51 is provided on the first main surface 141 of the base material 14 and is made of copper, aluminum, or the like, for example. For example, by etching or printing, a copper film or an aluminum film is formed on the first main surface 141 of the base material 14, to provide the inductor 51 on the first main surface 141 of the base material 14. The inductor 51 is provided on the first main surface 141 of the base material 14 together with the first coil conductor portion 21 of the first inductor 2 and the third coil conductor portion 31 of the second inductor 3.

Here, the inductor 51 provided in a spiral shape may be a two-dimensional coil conductor having a shape that is wound a plurality of times around a winding axis in a spiral shape on one plane, or may be a three-dimensional coil conductor having a shape that is wound a plurality of times in a helical shape around and along a winding axis. FIG. 2A shows the two-dimensional coil conductor. Note that, as shown in FIG. 2A, the inductor 51 is wound to have a triangular or a substantially triangular shape in a plan view from the first direction D1.

In the antenna device 1 having such circuitry, as shown in FIG. 1, only the first inductor 2 is used in wireless communication via the first communication frequency as a carrier frequency. On the other hand, in wireless communication via the second communication frequency as a carrier frequency, both the first inductor 2 and the second inductor 3 are used.

Incidentally, when the first system circuit 71 operates, inductance of the inductor 51 and capacitance of the capacitor 52 of the parallel resonant circuit 5 are preferably set such that an absolute value |Δθs| of a phase difference between the first current flowing in the first inductor 2 and the second current flowing in the second inductor 3 is less than about 90°.

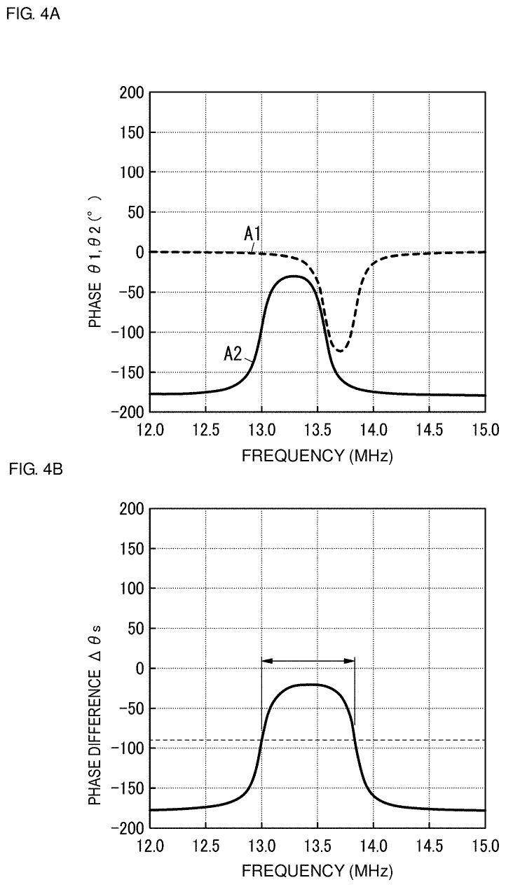

FIG. 4A shows phase characteristics A1 of the first current flowing in the first inductor 2 and phase characteristics A2 of the second current flowing in the second inductor 3. A parallel resonant frequency of the parallel resonant circuit 5 is about 13 MHz.

When the parallel resonant circuit 5 is not provided, and the first system circuit 71 operates, the first current flowing in the first inductor 2 and the second current flowing in the second inductor 3 weaken each other. Since the first inductor 2 and the second inductor 3 are coaxially provided, strong magnetic field coupling acts on the first inductor 2 and the second inductor 3. Accordingly, the currents having opposing phases to each other flow in the first inductor 2 and the second inductor 3 respectively. When the parallel resonant circuit 5 is not provided, a phase θ1 of the first current is always about 0°, and a phase θ2 of the second current is always about −180°.

When the parallel resonant circuit 5 is provided and the first system circuit 71 operates, the phase θ1 of the first current flowing in the first inductor 2 is normally about 0°, and the phase of the second current flowing in the second inductor 3 is normally about −180°. However, the phase θ1 of the first current and the phase θ2 of the second current vary in specific frequency bands respectively, according to the inductance and the capacitance of the parallel resonant circuit 5. The phase θ2 of the second current varies on a lower frequency side than the phase θ1 of the first current.

The absolute value |Δθₛ| of the phase difference between the phase θ1 of the first current and the phase θ2 of the second current varies as shown in FIG. 4B, due to the above phase characteristics A1 and A2. When the absolute value |Δθₛ| of the phase difference is equal to or more than about 0° and less than about 90°, good characteristics are obtained. When the parallel resonant frequency of the parallel resonant circuit 5 is about 13 MHz for example, good characteristics are obtained when the first communication frequency falls within a range of about 13 MHz to about 13.8 MHz. Note that, FIG. 4B shows the phase difference Δθₛ between the phase θ1 of the first current and the phase θ2 of the second current.

Next, a description will be provided of a frequency band of the first communication frequency in which the absolute value |Δθₛ| of the phase difference is about 0° or more and less than about 90° when the first system circuit 71 operates.

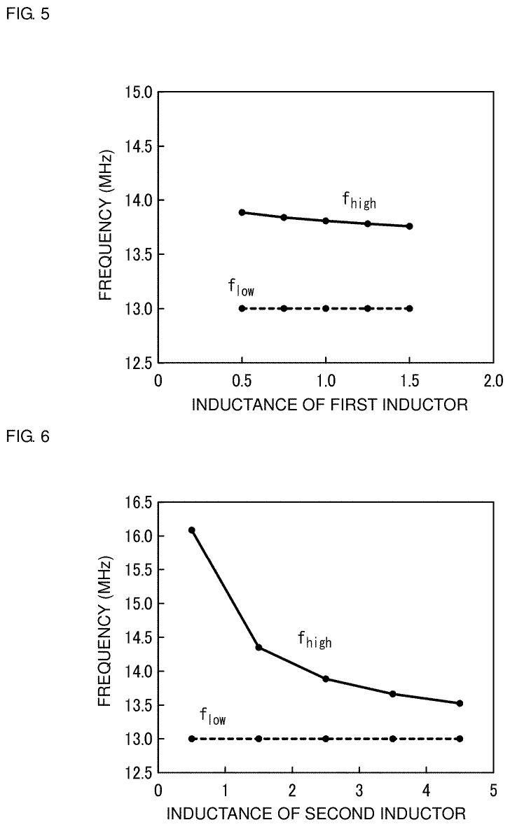

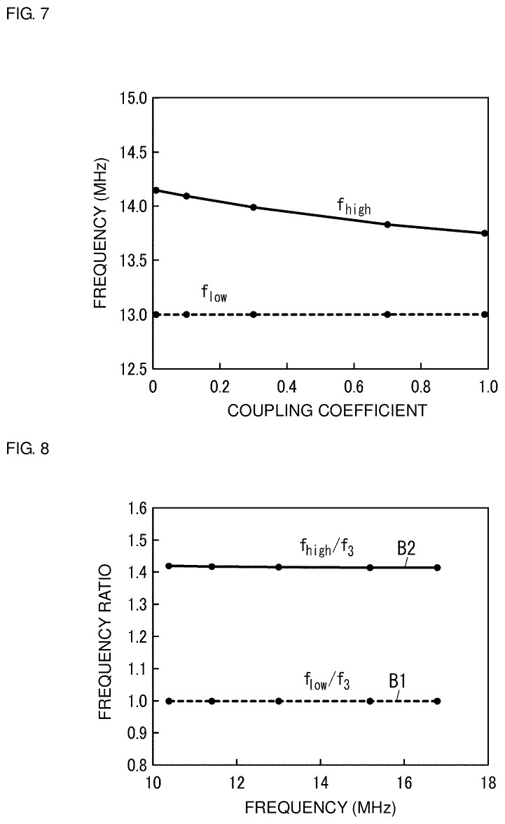

A minimum frequency flow in the frequency band of the first communication frequency in which the absolute value |Δθₛ| of the phase difference is equal to or more than about 0° and less than about 90° is constant, regardless of any one of inductance of the first inductor 2, inductance of the second inductor 3, and a coupling coefficient between the first inductor 2 and the second inductor 3, as shown in FIG. 5 to FIG. 7. On the other hand, a maximum frequency f_{high} in the frequency band of the first communication frequency in which the absolute value |Δθₛ| of the phase difference is about 0° or more and less than about 90° has a negative correlation with any of the inductance of the first inductor 2, the inductance of the second inductor 3, and the coupling coefficient, as shown in FIG. 5 to FIG. 7. In other words, as shown in FIG. 5, as the inductance of the first inductor 2 becomes smaller, the maximum frequency f_{high} becomes larger. As shown in FIG. 6, as the inductance of the second inductor 3 becomes smaller, the maximum frequency f_{high} becomes larger. As shown in FIG. 7, as the coupling coefficient becomes smaller, the maximum frequency f_{high} becomes larger.

FIG. 8 shows a ratio (f_{low}/f₃) of the minimum frequency f_{low} in the frequency band of the first communication frequency to a parallel resonant frequency f₃ of the parallel resonant circuit 5 and a ratio (f_{high}/f₃) of the maximum frequency f_{high} in the above frequency band to the parallel resonant frequency f₃ of the parallel resonant circuit 5, when the maximum frequency f_{high} becomes maximum in the present preferred embodiment, specifically when the inductance of the first inductor 2 is equal or substantially equal to the inductance of the inductor 51, the inductance of the second inductor 3 is equal or substantially equal to that of the inductor 51, and the coupling coefficient between the first inductor 2 and the second inductor 3 is about 0.01. Due to characteristics B1 in FIG. 8, the ratio (f_{low}/f₃) of the minimum frequency f_{low} in the above frequency band to the parallel resonant frequency f₃ of the parallel resonant circuit 5 is about 1. That is, the minimum frequency f_{low} in the above frequency band is equal or substantially equal to the parallel resonant frequency f₃ of the parallel resonant circuit 5. Further, due to characteristics B2 in FIG. 8, the ratio (f_{high}/f₃) of the maximum frequency f_{high} in the above frequency band to the parallel resonant frequency f₃ of the parallel resonant circuit 5 is equal or substantially equal to or less than about 1.6. In the characteristic B2 in FIG. 8, the ratio (f_{high}/f₃) of the maximum frequency f_{high} in the above frequency band to the parallel resonant frequency f₃ is about 1.43.

From the above, in order for the absolute value |Δθₛ| of the phase difference to be equal to or more than about 0° and less than about 90°, it is sufficient that the first communication frequency is equal to or more than about 1 times and equal to or less than about 1.6 times the parallel resonant frequency f₃ of the parallel resonant circuit 5.

### (2.6) Filter

As shown in FIG. 1, the filter 11 includes two inductors 111 and two capacitors 112. Each of the inductors 111 is provided on a first path connecting the first inductor 2 and the first system circuit 71. Each of the capacitors 112 is provided on a path between a node between the inductor 111 and the first inductor 2 on the first path, and a ground.

### (2.7) Connection Terminal

As shown in FIG. 3, the three connection terminals (the first connection terminal 16, the second connection terminal 17, and the third connection terminal 18) are provided on the second main surface 142 of the base material 14 (see FIG. 2B) that electrically connects a circuit board 81 (see FIG. 9A) of the electronic apparatus 8, to the first inductor 2 and the second inductor 3. As shown in FIG. 1, the first connection terminal 16 is electrically connected between the first inductor 2 and the second inductor 3. The second connection terminal 17 is electrically connected to another end of the first inductor 2. The third connection terminal 18 is electrically connected to the parallel resonant circuit 5.

### (2.8) First Protection Layer and Second Protection Layer

The first protection layer (not shown) covers the first coil conductor portion 21 and the third coil conductor portion 31 provided on the first main surface 141 of the base material 14 shown in FIG. 2B, and protects the first coil conductor portion 21 and the third coil conductor portion 31 from external force or the like. The first protection layer preferably has a plate or a sheet shape and is made of an electrically insulating material such as resin, for example. In a plan view from the first direction D1, the planar shape of the first protection layer is preferably the same or substantially the same shape as that of the base material 14. The first protection layer is attached to the first main surface 141 of the base material 14 with an adhesive layer (not shown) interposed therebetween.

The second protection layer (not shown) covers the second coil conductor portion 22 and the fourth coil conductor portion 32 provided on the second main surface 142 of the base material 14 shown in FIG. 2B, and protects the second coil conductor portion 22 and the fourth coil conductor portion 32 from external force or the like. Similarly to the first protection layer, the second protection layer preferably has a plate or a sheet shape and is made of an electrically insulating material such as resin, for example. In a plan view from the first direction D1, the planar shape of the second protection layer is preferably the same or substantially the same shape as that of the base material 14. The second protection layer is attached to the second main surface 142 of the base material 14 with an adhesive layer (not shown) interposed therebetween.

### (2.9) Magnetic Body

As shown in FIG. 2B, at least a portion of the magnetic body 15 overlaps with the first inductor 2 and the second inductor 3 in a plan view of the first inductor 2 and the second inductor 3. More specifically, the magnetic body 15 is provided facing the second coil conductor portion 22 and the fourth coil conductor portion 32 in the first direction D1. The magnetic body 15 preferably has a rectangular or substantially rectangular plate or a rectangular or substantially rectangular sheet shape and is made a ferromagnetic material such as ferrite, for example. The magnetic body 15 has magnetic permeability higher than that of the base material 14. Examples of the ferromagnetic material included in the magnetic body 15 include, for example, Ni—Zn—Cu ferrite, Mn—Zn—Fe ferrite, or hexagonal ferrite. The magnetic body 15 is closer to the second coil conductor portion 22 and the fourth coil conductor portion 32 than the first coil conductor portion 21 and the third coil conductor portion 31.

### (3) Communication System

As shown in FIG. 1, the communication system 7 includes the antenna device 1, the first system circuit 71, and the second system circuit 72. The first system circuit 71 is a circuit that performs wireless communication via the first communication frequency as a carrier frequency. The second system circuit 72 is a circuit that performs wireless communication via the second communication frequency as a carrier frequency.

### (4) Electronic Apparatus

As shown in FIGS. 9A to 9C, the electronic apparatus 8 includes the antenna device 1, the circuit board 81, and a housing 82. The electronic apparatus 8 is preferably, for example, a cellular phone including a smartphone, a wearable device, a wristwatch terminal, a headphone, or a hearing aid. The circuit board 81 includes a system circuit that operates the antenna device 1. The housing 82 accommodates the antenna device 1 and the circuit board 81. The housing 82 preferably has a rectangular or substantially rectangular parallelepiped shape, and has a longitudinal direction D31 and a short direction D32. Further, the electronic apparatus 8 includes a plurality of circuit elements 83 provided on the circuit board 81, a battery 84 that drives the electronic apparatus 8, and a display device 85 that display predetermined information. The antenna device 1 is accommodated in the housing 82 such that a thickness direction of the base material 14 is along a height direction D33 of the housing 82.

### (5) Advantageous Effects

As described above, in the antenna device 1 according to the first preferred embodiment, the parallel resonant circuit 5 that resonates at the parallel resonant frequency lower than the first communication frequency is connected in series with the first inductor 2 and the second inductor 3. Accordingly, when the first system circuit 71 operates, the first current flowing in the first inductor 2 and the second current flowing in the second inductor 3 are able to be prevented from canceling each other out. As a result, it is possible to significantly reduce or prevent a decrease in communication distance when the first system circuit 71 operates.

According to the antenna device 1 of the first preferred embodiment, there is no need for a switch that switches between operating the first system circuit 71 and operating the second system circuit 72. As a result, compared to a case where a switch is provided, the antenna device 1 is able to be made smaller, and a cost is able to be reduced.

In the antenna device 1 according to the first preferred embodiment, an inductance of the inductor 51 (inductance component) and a capacitance of the capacitor 52 (capacitance component) of the parallel resonant circuit 5 are preferably set such that the absolute value |Δθₛ| of the phase difference between the first current of the first inductor 2 and the second current of the second inductor 3 is less than about 90°. Thus, the intensity of a magnetic field generated in the first inductor 2 and the second inductor 3 is able to be increased.

In the antenna device 1 according to the first preferred embodiment, the first communication frequency is preferably, for example, about 1.6 times or less the parallel resonant frequency. Accordingly, it is possible to further significantly reduce or prevent the first current flowing in the first inductor 2 and the second current flowing in the second inductor 3 from canceling each other out.

In the antenna device 1 according to the first preferred embodiment, the first inductor 2 and the second inductor 3 are integrally provided on the single base material 14. Accordingly, the entire antenna device 1 is able to be made smaller.

In the antenna device 1 according to the first preferred embodiment, the parallel resonant circuit 5 is provided outside a region of the base material 14 where the first inductor 2 and the second inductor 3 are provided. Accordingly, unnecessary magnetic field coupling between the first inductor 2 and the second inductor 3, and the inductor 51 included in the parallel resonant circuit 5 is able to be reduced, and the parallel resonant circuit 5 is able to be provided on the base material 14 on which the first inductor 2 and the second inductor 3 are integrally provided.

### (6) Modified Examples

Modified examples of the first preferred embodiment will be described below.

A magnetic body having low loss characteristics at the first communication frequency (for example, 13.56 MHz) may be included only in a portion where the inductor 51 is provided. As a material of the above magnetic body, a material having high permeability not only at the second communication frequency but also at the first communication frequency, such as Ni—Zn—Fe ferrite is preferable, for example. Thus, a Q value of a resonant circuit in the first communication frequency band is able to be increased.

A magnetic body may be provided on an upper side of the inductor 51. Thus, the Q value of the resonant circuit is able to be increased. Further, the inductance of the inductor 51 is able to be increased. As a result, a degree of freedom in design is able to be enhanced.

The inductor 51 may preferably be a chip component, for example. This makes it possible to reduce an occupied area.

The capacitor 52 may include two pattern conductors provided on the base material 14 and a dielectric body between the two pattern conductors, instead of a chip component.

The inductor 51 may include a plurality of coil conductors that cancel or substantially cancel a leakage magnetic field of the second inductor 3. For example, a way of winding the inductor 51 and a method of wire connection are adjusted. Accordingly, coupling between the inductor 51 and the second inductor 3 is able to be reduced, and influence of the coupling is able to be reduced. As a result, it is possible to easily set a resonant frequency.

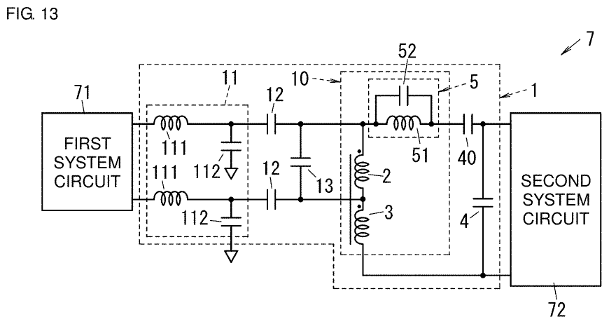

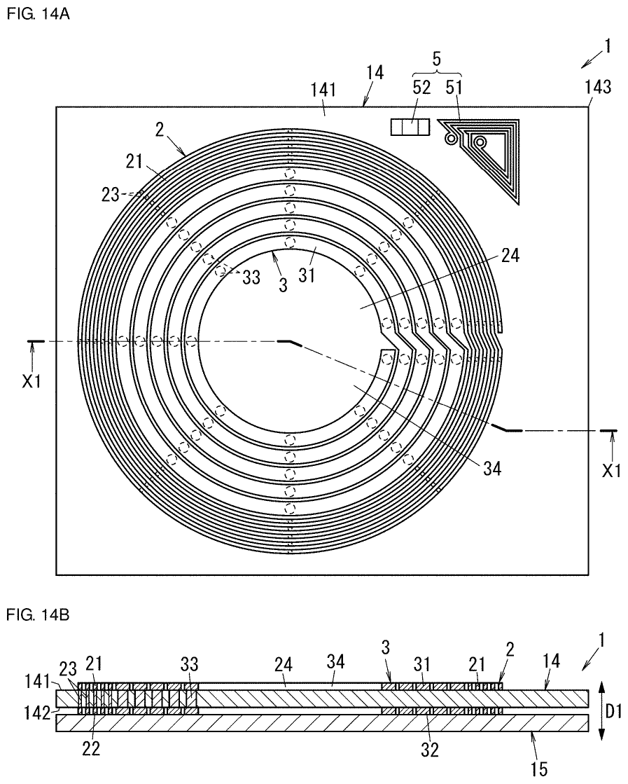

As shown in FIG. 13, the first inductor 2 and the second inductor 3 may be reversed in the circuitry shown in FIG. 1. That is, the first inductor 2 may be connected between the second inductor 3 and the parallel resonant circuit 5.

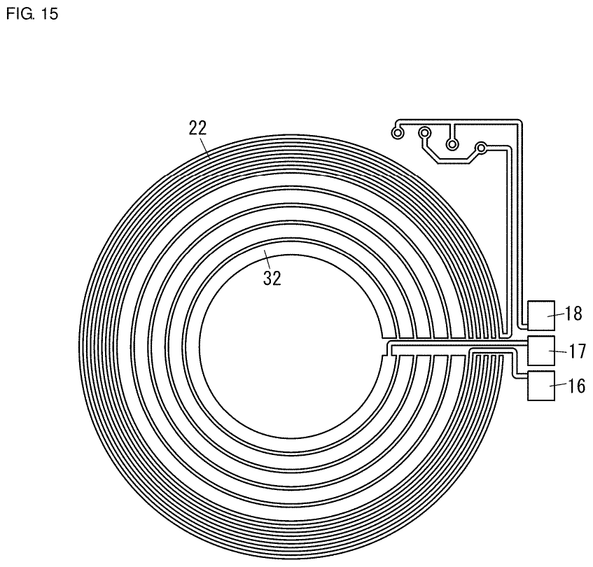

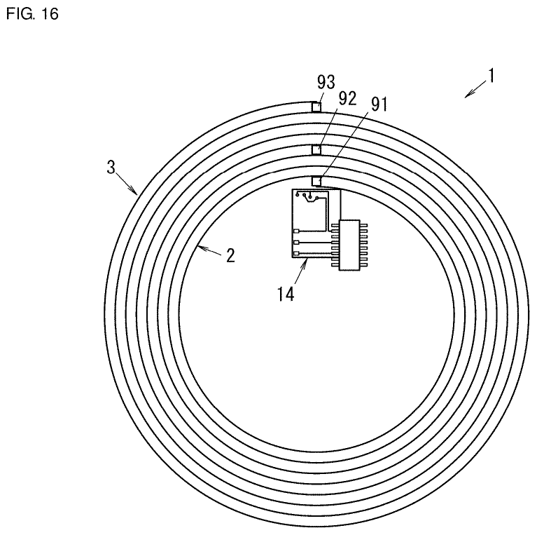

Further, as shown in FIGS. 14A, 14B, and FIG. 15, the first inductor 2 and the second inductor 3 may be replaced in FIGS. 2A, 2B and FIG. 3, respectively. Accordingly, an outer shape of the first inductor 2 is able to be enlarged, so that a leakage range of a magnetic field is able to be widened.

In the first preferred embodiment, all of the first opening 24 of the first inductor 2 overlaps with the second opening 34 of the second inductor 3, but it is also possible that only a portion of the first opening 24 of the first inductor 2 overlaps with the second opening 34 of the second inductor 3. In short, it is sufficient that at least a portion of the first opening 24 of the first inductor 2 overlaps with the second opening 34 of the second inductor 3.

Moreover, it is not necessary that the first coil conductor portion 21 and the second coil conductor portion 22 completely overlap with each other. Similarly, it is not necessary that the third coil conductor portion 31 and the fourth coil conductor portion 32 completely overlap with each other.

As a modified example of the first preferred embodiment, the antenna device 1 need not include the magnetic body 15. That is, the magnetic body 15 is not a required component.

A shape of each of the first inductor 2 and the second inductor 3 is not limited to a circular shape. The first inductor 2 and the second inductor 3 may have an elliptical shape in a plan view from the first direction D1, or may have a rectangular or substantially rectangular shape such as an oblong shape or a square or substantially square shape. Alternatively, the first inductor 2 and the second inductor 3 may have a polygonal shape other than a rectangular or substantially rectangular shape.

A shape of the inductor 51 is not limited to a triangular or substantially triangular shape. The inductor 51 may have a circular shape in a plan view from the first direction D1, or may have an elliptical shape, or have a rectangular or substantially rectangular shape such as an oblong shape or a square or substantially square shape. Alternatively, the inductor 51 may have a polygonal shape other than a triangular or substantially triangular shape and a quadrangular or substantially quadrangular shape.

Further, the first inductor 2 is not limited to two-layered structure including the first coil conductor portion 21 and the second coil conductor portion 22, and may have structure including three or more layers. In short, the first inductor 2 may include three or more coil conductor portions. Similarly, the second inductor 3 is not limited to the two-layered structure including the third coil conductor portion 31 and the fourth coil conductor portion 32, and may have structure including three or more layers. In short, the second inductor 3 may include three or more coil conductor portions.

Further, the number of loops (number of turns) of each of the first coil conductor portion 21 and the second coil conductor portion 22 of the first inductor 2 is not limited to five. The first coil conductor portion 21 and the second coil conductor portion 22 may be wound about four times or less, or may be wound about six times or more.

Similarly, the number of loops (number of turns) of each of the third coil conductor portion 31 and the fourth coil conductor portion 32 of the second inductor 3 is not limited to five. The third coil conductor portion 31 and the fourth coil conductor portion 32 may be wound about four times or less, or may be wound about six times or more.

Further, the antenna device 1 may include a base material made of, for example, a magnetic material instead of the base material 14 made of the electrically insulating material such as resin, for example. Even when a base material is made of a magnetic material, the first inductor 2, the second inductor 3, and the inductor 51 are directly provided on the base material of the magnetic material. In addition, when the base material is made of the magnetic material, the base material is able to be included also as a magnetic body. Thus, a thickness of the base material of the antenna device 1 in the thickness direction (first direction D1) is able to be reduced.

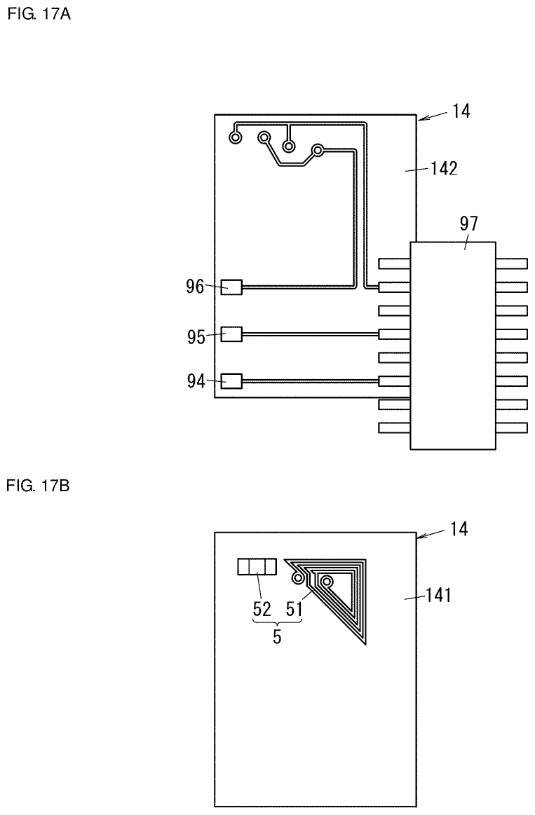

As shown in FIG. 16, the first inductor 2 and the second inductor 3 may be made of a wire. In this case, as shown in FIGS. 17A and 17B, the parallel resonant circuit 5 is provided on the base material 14, but the first inductor 2 and the second inductor 3 are not provided.

As shown in FIG. 16, the antenna device 1 includes a first terminal 91, a second terminal 92, and a third terminal 93. The first terminal 91 is provided at one end of the first inductor 2. The second terminal 92 is provided between the first inductor 2 and the second inductor 3. The third terminal 93 is provided at one end of the second inductor 3.

As shown in FIG. 17B, the antenna device 1 includes a first terminal 94, a second terminal 95, and a third terminal 96. The first terminal 94, the second terminal 95, and the third terminal 96 are provided on the second main surface 142 of the base material 14. The first terminal 94 and the second terminal 95 are electrically connected to a connector component 97, and the third terminal 96 is electrically connected to the parallel resonant circuit 5. The first terminal 94 is electrically connected to the first terminal 91, the second terminal 95 is electrically connected to the second terminal 92, and the third terminal 96 is electrically connected to the third terminal 93.

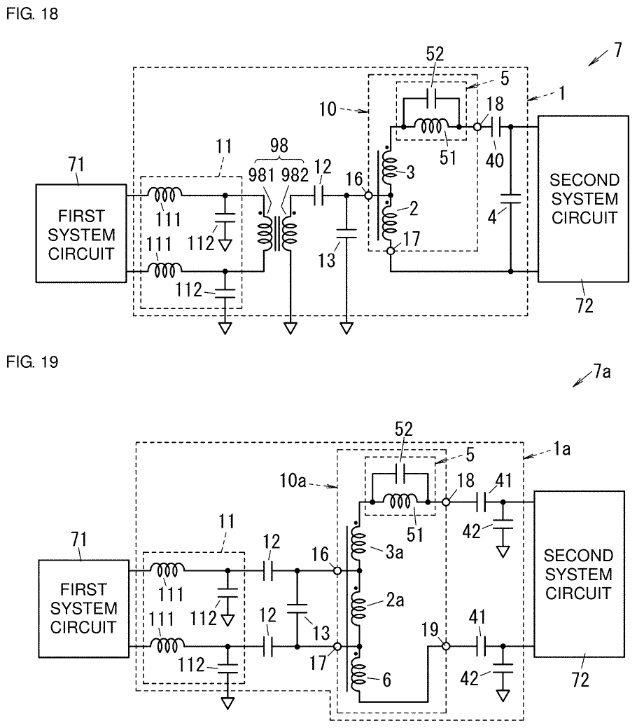

The communication system 7 may have a circuitry as shown in FIG. 18. The communication system 7 may switch transmission on a side of the first system from balanced transmission to unbalanced transmission (single end transmission).

The communication system 7 shown in FIG. 18 includes one number of the series capacitor 12 and a transformer 98. The transformer 98 includes a primary winding 981 and a secondary winding 982. The primary winding 981 is connected to a side of the first system circuit 71. More specifically, the primary winding 981 is connected to the filter 11. The secondary winding 982 is connected to a side of the antenna device 1. In more detail, the secondary winding 982 is electrically connected between the first inductor 2 and the second inductor 3 with the series capacitor 12 located therebetween.

The antenna device 1 according to each of the above modified examples also has the same or substantially the same advantageous effects as those of the antenna device 1 according to the first preferred embodiment.

### Second Preferred Embodiment

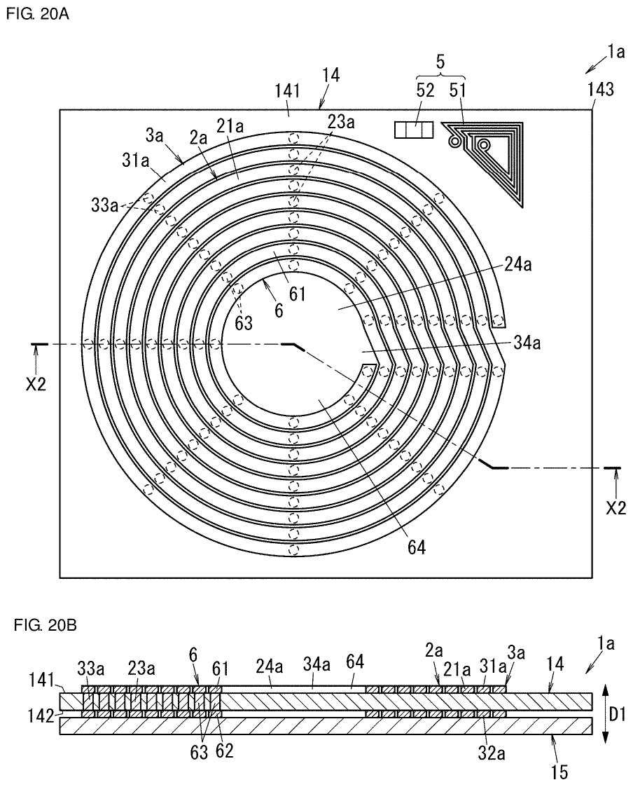

An antenna device 1a according to a second preferred embodiment of the present invention is different from the antenna device 1 according to the first preferred embodiment (see FIG. 1) in that a third inductor 6 is provided as shown in FIG. 19. Note that, in the antenna device 1a according to the second preferred embodiment, elements the same as or similar to those of the antenna device 1 according to the first preferred embodiment are assigned the same reference numerals, and description thereof will be omitted.

As shown in FIG. 19, the antenna device 1a according to the second preferred embodiment includes the third inductor 6. Further, the antenna device 1a includes a first inductor 2a and a second inductor 3a instead of the first inductor 2 and the second inductor 3 (see FIG. 1). Further, the antenna device 1a includes a plurality of capacitors 41 and 42 (four capacitors in the illustrated example) instead of the capacitors 4 and 40 (see FIG. 1). A circuit block 10a shown in FIG. 19 is provided on the base material 14 (see FIG. 20).

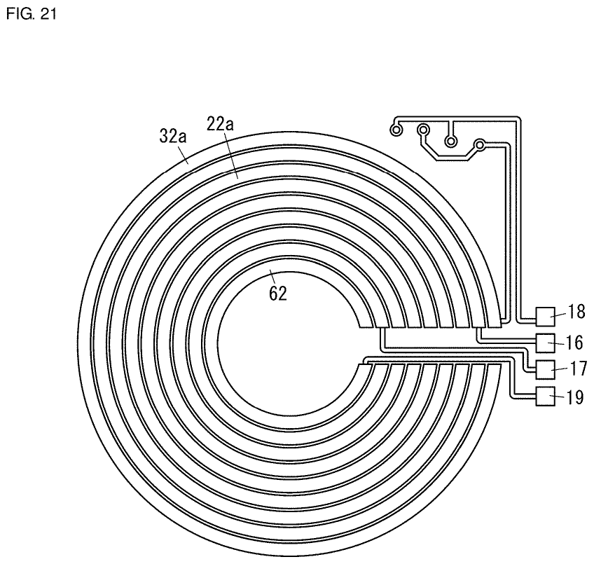

As shown in FIGS. 20A, 20B, and FIG. 21, the first inductor 2a includes a first coil conductor portion 21a, a second coil conductor portion 22a, and a first via conductor 23a, and has a first opening 24a, as in the first preferred embodiment. Similarly to the first preferred embodiment, the second inductor 3a includes a third coil conductor portion 31a, a fourth coil conductor portion 32a, and a second via conductor 33a, and has a second opening 34a.

As shown in FIG. 19, the third inductor 6 defines a resonant circuit together with the first inductor 2a, the second inductor 3a, and the parallel resonant circuit 5. The third inductor 6 is electrically connected between an end of the first inductor 2a opposite to an end connected to the second inductor 3a, and the second system circuit 72.

When the second system circuit 72 operates, impedance of the third inductor 6 is set in advance to be equal or substantially equal to impedance of the second inductor 3a and the parallel resonant circuit 5.

In the antenna device 1a according to the second preferred embodiment, the first inductor 2a, the second inductor 3a, and the third inductor 6 are provided on the base material 14 as shown in FIGS. 20A, 20B, and FIG. 21. The third inductor 6 is provided on an inside of innermost circumferences of the first inductor 2a and the second inductor 3a.

As shown in FIGS. 20A, 20B, and FIG. 21, the third inductor 6 is provided on the base material 14, and is wound in a spiral shape. The third inductor 6 includes a third opening 64. More specifically, the third inductor 6 includes a fifth coil conductor portion 61, a sixth coil conductor portion 62, and a plurality of third via conductors 63. In order to reduce a resistance component of the third inductor 6, the fifth coil conductor portion 61 and the sixth coil conductor portion 62 are electrically connected in parallel, and the fifth coil conductor portion 61 and the sixth coil conductor portion 62 are electrically connected by the plurality of third via conductors 63.

As shown in FIGS. 20A and 20B, the fifth coil conductor portion 61 is provided in a spiral shape about the axis along the first direction D1. The fifth coil conductor portion 61 is preferably, for example, wound about twice. The fifth coil conductor portion 61 is provided on the first main surface 141 of the base material 14 and is preferably made copper, aluminum, or the like, for example. For example, by etching or printing, a copper film or an aluminum film is formed on the first main surface 141 of the base material 14, to provide the fifth coil conductor portion 61 on the first main surface 141 of the base material 14.

Similarly to the fifth coil conductor portion 61, the sixth coil conductor portion 62 is provided in a spiral shape about the axis along the first direction D1 as shown in FIG. 20B and FIG. 21. The sixth coil conductor portion 62 is preferably, for example, wound about twice. The sixth coil conductor portion 62 is provided on the second main surface 142 of the base material 14 and is preferably made of copper, aluminum, or the like, for example. For example, by etching or printing, a copper film or an aluminum film is formed on the second main surface 142 of the base material 14, to provide the sixth coil conductor portion 62 on the second main surface 142 of the base material 14.

Here, each of the coil conductor portions (the fifth coil conductor portion 61 and the sixth coil conductor portion 62) provided in a spiral shape may be a two-dimensional coil conductor portion having a shape that is wound a plurality of times around a winding axis in a spiral shape on one plane, or may be a three-dimensional coil conductor portion having a shape that is wound a plurality of times in a helical shape around and along a winding axis. FIG. 20A and FIG. 21 show the two dimensional coil conductor portion.

The sixth coil conductor portion 62 is located at a position overlapping with the fifth coil conductor portion 61 in a plan view from the first direction D1. The sixth coil conductor portion 62 is disposed along the fifth coil conductor portion 61 in a plan view from the first direction D1. In other words, the sixth coil conductor portion 62 does not intersect the fifth coil conductor portion 61, but is disposed such that a longitudinal direction of the sixth coil conductor portion 62 coincides or substantially coincides with a longitudinal direction of the fifth coil conductor portion 61.

As described above, since the sixth coil conductor portion 62 overlaps with the fifth coil conductor portion 61, the third inductor 6 is able to be prevented from becoming larger while increasing the third opening 64 surrounded by the fifth coil conductor portion 61 and the sixth coil conductor portion 62.

The plurality of third via conductors 63 is connected in parallel to each other between the fifth coil conductor portion 61 and the sixth coil conductor portion 62, and penetrates through the base material 14. As shown in FIG. 20A, the plurality of third via conductors 63 is provided at different positions from each other in a plan view from the first direction D1 to electrically connect the fifth coil conductor portion 61 and the sixth coil conductor portion 62. The plurality of third via conductors 63 is provided at different positions from each other within the base material 14.

The fifth coil conductor portion 61 and the sixth coil conductor portion 62 are electrically connected to each other by the plurality of third via conductors 63. Accordingly, a current is able to flow in the first direction D1 through the third via conductors 63, so that a resistance component is able to be made smaller than that in a case where the third inductor 6 includes only of the fifth coil conductor portion 61 or only of the sixth coil conductor portion 62.

The fifth coil conductor portion 61 is connected to the first coil conductor portion 21a of the first inductor 2a. The first coil conductor portion 21a is connected to the third coil conductor portion 31a of the second inductor 3a similar to the connection in the first preferred embodiment. The sixth coil conductor portion 62 is connected to the second coil conductor portion 22a of the first inductor 2a. The second coil conductor portion 22a is connected to the fourth coil conductor portion 32a of the second inductor 3a similar to the connection in the first preferred embodiment. Note that, similar to the first preferred embodiment, the first coil conductor portion 21a and the second coil conductor portion 22a are electrically connected to each other by a plurality of the first via conductors 23a, and the third coil conductor portion 31a and the fourth coil conductor portion 32a are electrically connected to each other by a plurality of the second via conductors 33a.

As shown in FIG. 19, the antenna device 1a according to the second preferred embodiment includes four number of the connection terminals (the first connection terminal 16, the second connection terminal 17, the third connection terminal 18, and a fourth connection terminal 19). As shown in FIG. 21, the four connection terminals are provided on the second main surface 142 of the base material 14 (see FIG. 20B) to electrically connect the circuit board 81 (see FIG. 9A) of the electronic apparatus 8 to the first inductor 2a and the second inductor 3a. More specifically, the first connection terminal 16 is electrically connected between the first inductor 2a and the second inductor 3a. The second connection terminal 17 is electrically connected between the first inductor 2a and the third inductor 6. The third connection terminal 18 is electrically connected to the parallel resonant circuit 5. The fourth connection terminal 19 is electrically connected to one end of the third inductor 6.

Note that, the use example of the antenna device 1a according to the second preferred embodiment is included in a communication system 7a and the electronic apparatus 8 as in the antenna device 1 according to the first preferred embodiment.

As described above, in the antenna device 1a according to the second preferred embodiment, when the second system circuit 72 operates, the impedance of the third inductor 6 is the same or substantially the same as the impedance of the second inductor 3a and the parallel resonant circuit 5. Accordingly, respective ground levels of the two balanced circuits in the second system circuit 72 are able to be made equal or substantially equal.

As a modified example of the second preferred embodiment, the third inductor 6 may be provided outside an outermost periphery of the first inductor 2a and the second inductor 3a.

Also in the antenna device 1a according to the modified example described above, the same or substantially the same advantageous effects as those of the antenna device 1a according to the second preferred embodiment is able to be achieved.

The preferred embodiments and modified examples described above are only a portion of various preferred embodiments and modified examples of the present invention. In addition, as long as the advantageous effects of the present invention are able to be achieved, various modifications and variations are able to be made to the preferred embodiments and modified examples in accordance with the design or the like.

The following aspects are described based on the preferred embodiments and modified examples described above.

An antenna device (1; 1a) according to a preferred embodiment of the present invention is used together with the first system circuit (71) that performs wireless communication via the first communication frequency as a carrier frequency and the second system circuit (72) that performs wireless communication via the second communication frequency as a carrier frequency. The antenna device (1; 1a) includes the first inductor (2; 2a), the second inductor (3; 3a), and the parallel resonant circuit (5). The first inductor (2; 2a) has a spiral shape, has the first opening (24; 24a), and is electrically connected to the first system circuit (71). The second inductor (3; 3a) has a spiral shape, has the second opening (34; 34a) overlapping with the first opening (24; 24a) of the first inductor (2; 2a), and is connected to the first inductor (2; 2a). The first inductor (2; 2a) and the second inductor (3; 3a) are connected in series with the second system circuit (72). The second inductor (3; 3a) and the parallel resonant circuit (5) are connected to the first system circuit (71) in parallel with the first inductor (2; 2a). The parallel resonant circuit (5) resonates at the parallel resonant frequency lower than the first communication frequency.

According to an antenna device (1; 1a) according to a preferred embodiment of the present invention, when the first system circuit (71) operates, the first current flowing in the first inductor (2; 2a) and the second current flowing in the second inductor (3; 3a) are able to be prevented from canceling each other out. As a result, it is possible to significantly reduce or prevent a decrease in communication distance when the first system circuit (71) operates.

According to an antenna device (1; 1a) according to a preferred embodiment of the present invention, there is no need for a switch that switches between operating the first system circuit (71) and operating the second system circuit (72). As a result, compared to a case where a switch is provided, the antenna device (1; 1a) is able to be made smaller, and a cost is able to be reduced.

In an antenna device (1; 1a) according to a preferred embodiment of the present invention, the parallel resonant circuit (5) includes the inductance component (inductor 51) and the capacitance component (capacitor 52). When the first system circuit (71) operates, the inductance component and the capacitance component of the parallel resonant circuit (5) are set such that the absolute value |Δθₛ| of the phase difference between the first current flowing in the first inductor (2; 2a) and the second current flowing in the second inductor (3; 3a) is less than about 90°.

According to an antenna device (1; 1a) according to a preferred embodiment of the present invention, the intensity of the magnetic field generated by the first inductor (2; 2a) and the second inductor (3; 3a) is able to be increased.

In an antenna device (1; 1a) according to a preferred embodiment of the present invention, the first communication frequency is about 1.6 times or less the parallel resonant frequency.

According to an antenna device (1; 1a) according to a preferred embodiment of the present invention, it is possible to further significantly reduce or prevent the first current flowing in the first inductor (2; 2a) and the second current flowing in the second inductor (3; 3a) from canceling each other out.

An antenna device (1; 1a) according to a preferred embodiment of the present invention further includes the single base material (14). The first inductor (2; 2a) and the second inductor (3; 3a) are integrally provided on the base material (14).

According to an antenna device (1; 1a) according to a preferred embodiment of the present invention, the entire antenna device (1; 1a) is able to be made smaller.

In an antenna device (1; 1a) according to a preferred embodiment of the present invention, the parallel resonant circuit (5) is provided outside the region of the base material (14) where the first inductor (2; 2a) and the second inductor (3; 3a) are provided in a plan view of the base material (14).

According to an antenna device (1; 1a) according to a preferred embodiment of the present invention, the unnecessary magnetic field coupling between the first inductor (2; 2a) and the second inductor (3; 3a), and the inductor (51) included in the parallel resonant circuit (5) is able to be reduced, and the parallel resonant circuit (5) is able to be formed on the base material on which the first inductor 2 (2; 2a) and the second inductor 3(3; 3a) are integrally provided. (14).

An antenna device (1a) according to a preferred embodiment of the present invention further includes the third inductor (6). When the second system circuit (72) operates, the impedance of the third inductor (6) is equal to the synthetic impedance of the impedance of the second inductor (3; 3a) and the impedance of the parallel resonant circuit (5).

According to an antenna device (1a) according to a preferred embodiment of the present invention, the respective ground levels of the two balanced circuits in the second system circuit (72) are able to be made equal.

A communication system (7) according to a preferred embodiment of the present invention includes an antenna device (1; 1a) according to a preferred embodiment of the present invention, the first system circuit (71), and the second system circuit (72).

According to a communication system (7) according to a preferred embodiment of the present invention, in the antenna device (1; 1a), when the first system circuit (71) operates, the first current flowing in the first inductor (2; 2a) and the second current flowing in the second inductor (3; 3a) are able to be prevented from canceling each other out. As a result, it is possible to significantly reduce or prevent a decrease in communication distance in the first system circuit (2; 2a).

According to a communication system (7) according to a preferred embodiment of the present invention, in the antenna device (1; 1a), there is no need for a switch that switches between operating the first system circuit (71) and operating the second system circuit (72). As a result, compared to a case where a switch is provided, the antenna device (1; 1a) is able to be made smaller, and a cost is able to be reduced.

An electronic apparatus (8) according to a preferred embodiment of the present invention includes an antenna device (1; 1a) according to a preferred embodiment of the present invention, the circuit board (81), and the housing (82). The circuit board (81) includes the system circuit that operates the antenna device (1; 1a). The housing (82) accommodates the antenna device (1; 1a) and the circuit board (81).

According to an electronic apparatus (8) according to a preferred embodiment of the present invention, in the antenna device (1; 1a), when the first system circuit (71) operates, the first current flowing in the first inductor (2; 2a) and the second current flowing in the second inductor (3; 3a) are able to be prevented from canceling each other out. As a result, it is possible to significantly reduce or prevent a decrease in communication distance in the first system circuit (71).

According to an electronic apparatus (8) according to a preferred embodiment of the present invention, in the antenna device (1; 1a), there is no need for a switch that switches between operating the first system circuit (71) and operating the second system circuit (72). As a result, compared to a case where a switch is provided, the antenna device (1; 1a) is able to be made smaller, and a cost is able to be reduced.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna device that operates with a first system circuit that performs wireless communication via a first communication frequency as a carrier frequency and a second system circuit that performs wireless communication via a second communication frequency as a carrier frequency, the antenna device comprising:
a first inductor that includes a first opening, that is electrically connected to the first system circuit, and that has a spiral shape;
a second inductor that includes a second opening overlapping with the first opening of the first inductor, that is connected to the first inductor, and that has a spiral shape; and
a parallel resonant circuit; wherein
the first inductor and the second inductor are connected in series with the second system circuit;
the second inductor and the parallel resonant circuit are connected to the first system circuit in parallel with the first inductor; and
the parallel resonant circuit resonates at a parallel resonant frequency lower than the first communication frequency.

2. The antenna device according to claim 1, wherein
the parallel resonant circuit includes:
an inductance component; and
a capacitance component; and
when the first system circuit operates, the inductance component and the capacitance component of the parallel resonant circuit are set such that an absolute value of a phase difference between a first current flowing in the first inductor and a second current flowing in the second inductor is less than about 90°.

3. The antenna device according to claim 1, wherein the first communication frequency is about 1.6 times or less the parallel resonant frequency.

4. The antenna device according to claim 1, further comprising a single base material on which the first inductor and the second inductor are integrally provided.

5. The antenna device according to claim 4, wherein the parallel resonant circuit is provided outside a region of the base material where the first inductor and the second inductor are provided in a plan view of the base material.

6. The antenna device according to claim 1, further comprising:
a third inductor; wherein
when the second system circuit operates, an impedance of the third inductor is equal or substantially equal to a synthetic impedance of an impedance of the second inductor and an impedance of the parallel resonant circuit.

7. A communication system, comprising:
the antenna device according to claim 1;
the first system circuit; and
the second system circuit.

8. An electronic apparatus, comprising:
the antenna device according to claim 1;
a circuit board including a system circuit that operates the antenna device; and
a housing that accommodates the antenna device and the circuit board.

9. The antenna device according to claim 1, wherein:
the first inductor includes a first coil conductor portion, a second coil conductor portion, and a plurality of first via conductors;
the first coil conductor portion and the second coil conductor portion are connected in parallel; and
the first coil conductor portion and the second coil conductor portion are electrically connected to each other by the plurality of first via conductors.

10. The antenna device according to claim 9, wherein the first coil conductor portion has a spiral shape about an axis along a thickness direction of the base material.

11. The antenna device according to claim 9, wherein the second coil conductor portion overlaps the first coil conductor portion in a plan view from a thickness direction of the base material.

12. The antenna device according to claim 1, wherein a line width of the second inductor is larger than a line width of the first inductor.

13. The antenna device according to claim 9, wherein
the second inductor includes a third coil conductor portion, a fourth coil conductor portion, and a plurality of second via conductors;
the third coil conductor portion and the fourth coil conductor portion are electrically connected in parallel;
the third coil conductor portion and the fourth coil conductor portion are electrically connected by the plurality of second via conductors;
a line width of the third coil conductor portion of the second inductor is larger than a line width of the first coil conductor portion of the first inductor; and
a line width of the fourth coil conductor portion of the second inductor is larger than a line width of the second coil conductor portion of the first inductor.

14. The antenna device according to claim 1, wherein
only the first inductor is used during wireless communication via a first communication frequency as a carrier frequency; and
both the first inductor and the second inductor are used during wireless communication via a second communication frequency as the carrier frequency.

15. The antenna device according to claim 14, further comprising a capacitor that is connected in parallel with the first inductor, the second inductor, and the parallel resonant circuit.

16. The antenna device according to claim 15, wherein an impedance of the capacitor at the first communication frequency is lower than an impedance of the capacitor at the second communication frequency.

17. The electronic apparatus according to claim 8, wherein the antenna device operates as a wireless power supply to the electronic apparatus.

18. The antenna device according to claim 1, further comprising:
a filter circuit connected in parallel with the first inductor, the second inductor, and the parallel resonant circuit; wherein
an impedance of the filter circuit varies according to a frequency band.
